(19) United States
(12) Patent Application Publication
(10) Pub. No.: US 2016/0316641 A1
(43) Pub. Date: Nov. 3, 2016

(54) Transparent cover element with high thermal insulation

(71) Applicant: Mustafa METIN, Dortmund (DE)

(72) Inventor: Mustafa METIN, Dortmund (DE)

(21) Appl. No.: 15/023,644

(22) PCT Filed: Sep. 4, 2014
(86) PCT No.: PCT/EP2014/068875

§ 371 Date: Mar. 21, 2016

(30) Foreign Application Priority Data
Sep. 27, 2013 (DE) 10 2013 110 700.1

(51) Int. Cl. A01G 9/14; E06B 3/677; B32B 17/06; E04C 2/54; E04C 2/38; B32B 7/12; E06B 3/66; E04C 2/34

(52) U.S. Cl. CPC A01G 9/1438; E06B 3/6612; E06B 3/677; E04C 2/34; E04C 2/543; E04C 2/38; E04C 2/3405; B32B 7/12; B32B 17/06; E06B 2009/2417

(57) ABSTRACT

The present invention concerns a transparent heat-insulating cover element (1), in particular for greenhouse covers, comprising a base body (10) comprising at least two parallel panel-shaped elements (5) being spaced apart from each other and at least one lateral edge profile (18, 18a, 19 19a) forming, in combination with the base body (10), at least one cavity (12) which is essentially sealed against the external atmosphere, wherein the base body (10) is, on at least one of its outer surfaces (9, 11) which is averted from the at least one cavity (12), force-fit joined with, preferably bonded to, a glass layer (14, 16).

### TECHNICAL FIELD

The invention concerns a translucent cover element with high thermal insulation properties which is suitable in particular to clad greenhouses or other buildings, a method for the manufacture of the same, an edge profile for a cover element in accordance with the invention, and a method for the vacuum evacuation of a cover element in accordance with the invention.

### STATE OF THE ART

Generic cover elements are known in the state of the art; they are typically used for the thermal insulation of buildings and greenhouses. They generally comprise hollow-profile or multi-wall sheets consisting of two or more plastic sheets separated by webs (ribs) which are typically made of translucent (thermoplastic) plastic. For example, the cover elements described in DE 101 41 314 A1 feature, along with high transparency in the area of visible light, fairly good thermal insulation properties.

However, the thermal insulation properties of such cover elements have proven not to be sufficient in view of constantly increasing energy costs.

For this reason, it has already been attempted to increase the thermal insulation properties of such cover elements, as described in DE 10 2009 045 108 A1, by creating a vacuum in the cavities of the cover element, for the creation of which an edge profile to connect the largely parallel principal areas of the multi-wall sheets is intended, featuring a vacuum valve which is sealable after evacuation of the cavities.

While initially, i.e. after taking into operation a greenhouse cover with such cover elements, thermal insulation is fairly satisfactory due to the vacuum created in the cavities of the cover element, heat insulation will inevitably decrease even after a short period of time because the translucent plastic materials used for these cover elements, particularly polymethyl methacrylate (PMMA) and/or polycarbonate (PC), will allow air to intrude into the cavities over the course of time due to their low material density.

Other cover elements consisting of generic hollow-profile or multi-wall sheets are already known, for example from DE 10 2004 032 357 A1, DE 43 00 480 A1, DE 40 42 265 A1, DE 299 17 402 U1, AT 382 664 B and DE 28 45 334. However, all those previously known elements have significant disadvantages, such as heavy weight, low transparency in the area of visible light, high flammability, condensation dripping onto the plant cultures beneath, fogged interior chambers, susceptibility to hailstorm damage and algae formation. For this reason, they are suitable for use in greenhouses only to a limited extent.

CH 635 276 AS refers to a composite panel in which a twin-wall sheet is connected to a glass panel by means of adhesive traces.

DE 93 11 430 U1 refers to multiple-layer glazing in which one glass panel each is applied on the exterior sides of a composite panel and the three components are then attached by means of a silicone rubber layer.

DE 10 2004 023 975 A1 refers to twin-sheet hollow profile segments using multi-wall sheets. Plastic hollow profile bodies are disclosed which are constructed of at least three spaced panels in a sandwich-type manner, the panels being welded together at their edges.

The present invention is therefore based on the technical problem of supplying an improved cover element of the generic kind which will continue to achieve very high thermal insulation properties even after extended periods of time and overcome the above-mentioned disadvantages of the state of the art.

### SUMMARY OF THE INVENTION

In accordance with the invention, the above-mentioned problem is solved by a translucent heat-insulating element in accordance with claim 1 and by a method for the manufacture of the same in accordance with claim 12. Claim 13 is directed at an edge profile for a cover element in accordance with the invention. Finally, claim 14 concerns a method for the vacuum evacuation of a cover element in accordance with the invention.

The cover element in accordance with the invention includes in its most general embodiment at least two spaced panel-shaped elements which form a base body and which are preferably made from a translucent thermoplastic material. In accordance with the invention, at least on the peripheral side of the lateral sides of the base body, an edge profile is provided, defining at least one cavity created by edge profile and base body. In this at least one cavity, a negative pressure which lies below the ambient pressure is created (referred to as “vacuum” in the following; measured at a sea level of 0 m). Preferably, the base body comprises a double-wall sheet (two spaced panel-shaped elements), or a triple- or four-wall sheet (three or four spaced panel-shaped elements). In accordance with the invention, the base body is covered with a glass layer on at least one of its exterior walls which is averted from at least one of the cavities.

In accordance with the invention, the glass layer is force-fitted to the base body, preferably using an adhesive.

In the method for the manufacture of a translucent heat-insulating cover element in accordance with the invention, initially a base body as described above and a lateral edge profile are provided. The base body is then force-fitted with a glass layer, preferably using an adhesive, on at least one of its exterior walls which is averted from the cavities.

The present invention also relates to an edge profile for a translucent heat-insulating cover element, which is at least partly filled with an elastomer. This elastomer can be pierced, using a hollow needle or cannula, for the purpose of an at least partial vacuum evacuation of one or several cavities of the cover element. In accordance with the invention, the penetration point created in this way is immediately, i.e. during the removal of the hollow needle, sealed due to the material properties of the elastomer so that it is essentially gas-tight.

In the method in accordance with the invention for the vacuum evacuation of a translucent heat-insulating cover element, an elastomer provided in an edge profile is pierced using a hollow needle or cannula, and at least one cavity of the cover element is at least partially vacuum-evacuated. During the removal of the hollow needle, the penetration point created in this way is immediately sealed due to the material properties of the elastomer.

Additional advantageous embodiments of the cover element, the edge profile and the related methods in accordance with the invention are specified in the dependent claims.

### BRIEF DESCRIPTION OF THE FIGURES

Additional features and advantages of the invention arise from the following description which specifies exemplary embodiments on the basis of the accompanying figures in detail.

The figures illustrate as follows:

FIG. 1 an exemplary embodiment of a cover element in accordance with the invention, featuring a triple-wall sheet;

FIG. 2 an exemplary embodiment of a cover element in accordance with the invention, featuring a double-wall sheet;

FIG. 3 another exemplary embodiment of a cover element in accordance with the invention in an exploded view prior to the formation of a largely circumferential, partially elastic edge profile;

FIG. 4 a perspective oblique view of the exemplary embodiment in accordance with FIG. 3, in which the largely circumferential edge profile is mounted to have a sealing function and the edge profile features a primary and secondary structure consisting of an elastomer;

FIG. 5 an exploded view in accordance with FIG. 4 before the assembly of additional components;

FIG. 6a-d lengthwise cross-sectional views of the cover element in accordance with FIGS. 3 to 5; and

FIG. 7 a lengthwise cross-sectional view of the cover element in accordance with FIGS. 3 to 5.

### DESCRIPTION OF PREFERRED EMBODIMENTS

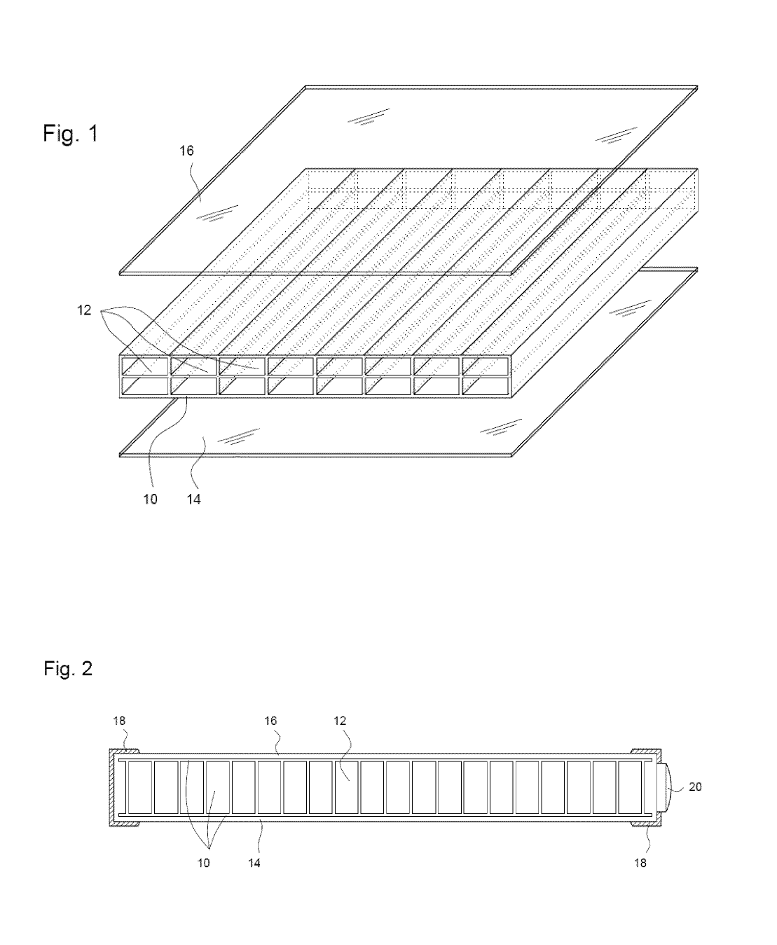

FIGS. 1 and 2 illustrate embodiments of a cover element using a triple- or double-wall sheet. In the following, for simplification, embodiments of the invention shall be explained using in particular the example of a double-wall sheet, although the concepts in accordance with the invention naturally also apply to other cover elements, irrespective of the number of sheets used.

The cover element (also referred to as “cladding element” herein) in accordance with FIG. 1 comprises a plastic base body 10 which has been produced in an extrusion process, in the example illustrated comprising polymethyl methacrylate (PMMA), which is overall translucent and features three panel-shaped parallel elements which are separated and at the same time connected by webs (ribs). The three panel-shaped elements as such and the webs (ribs) which connect them form cavities (also referred to herein as “hollow profiles”) 12. The side of the plastic base body which is at the bottom in FIG. 1 may be covered with a thin glass layer 14 with a thickness of 0.3 mm, while correspondingly the side of the plastic base body 10 which is at the top in FIG. 1 may also be covered with a corresponding thin glass layer 16.

All cavities 12 of the plastic base body 10, as illustrated in FIG. 2, are located close to an edge profile 18, which connects the glass layers 14, 16 in a gas-tight manner and are connected with the edge expansion space close to the edge profile 18 so that in one embodiment all cavities of the cover element may be evacuated through an evacuation valve 20. In this, the edge profile 18 including evacuation valve 20 may be attached to at least one or to all edges of the cover element in a way which allows all cavities 12 of the cover element to connect in a gastight manner with the evacuation valve 20.

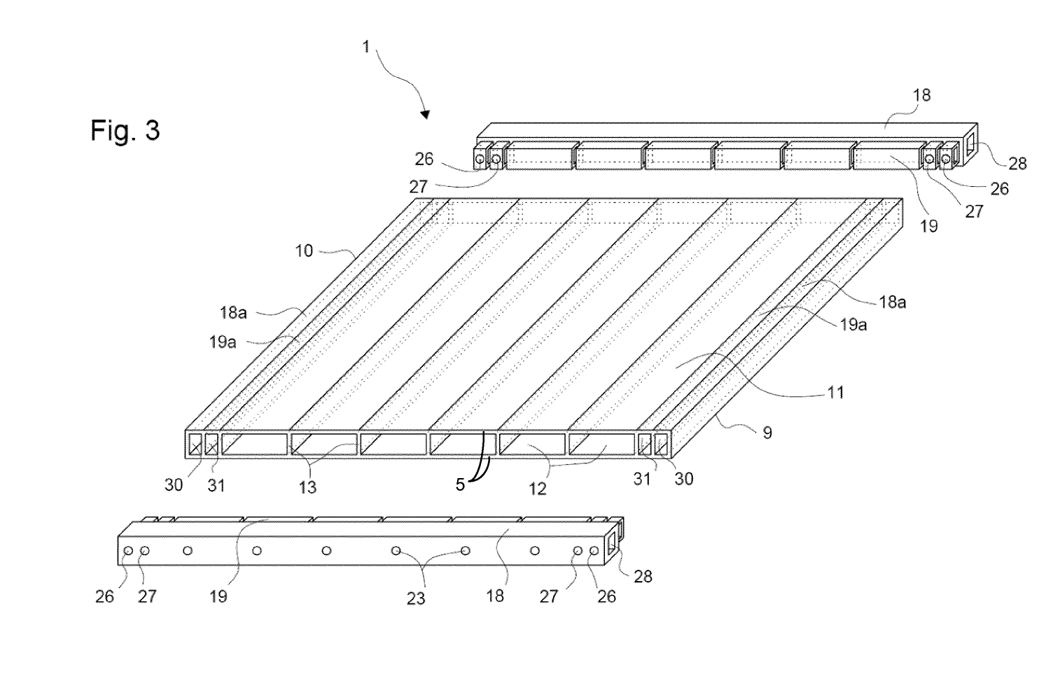

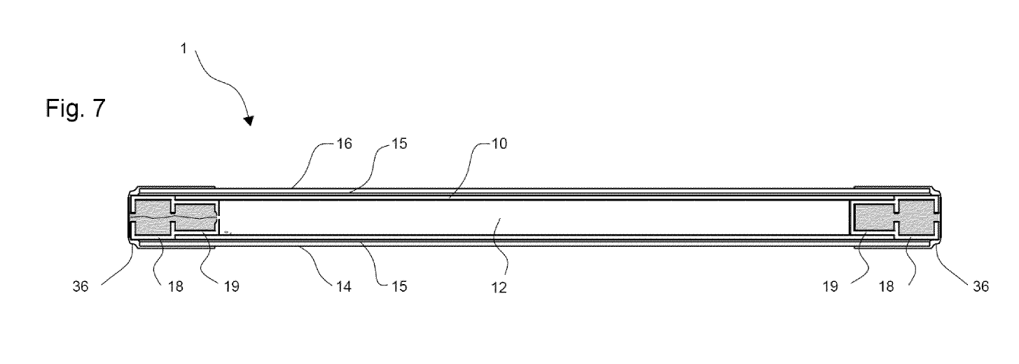

The sequence of FIGS. 3 to 7 illustrates the individual assembly stages for the manufacture of another embodiment of a cover element 1 in accordance with the invention. FIG. 3 shows an overall translucent plastic base body 10, produced in an extrusion process, featuring cavities 12 that consist of two panel-shaped elements 5 which are separated and at the same time connected by parallel webs (ribs) 13 and which define two exterior sides 9 and 11 of the base body 10. Here, the preferred embodiment of the plastic base body 10 consists for the large part of polymethyl methacrylate (PMMA), polycarbonate (PC) or of a (preferably more than 72%) translucent thermoplastic plastic. To reduce the expansion coefficient of the plastic base body 10, the addition of, among others, chemical components to the monomer and/or granulate material may be provided.

The components 18, 19 illustrated in FIG. 3 which serve to form the largely circumferential edge profile 18, 18a, 19, 19a comprise in this instance the same plastic as the plastic base body 10, are produced in an extrusion process and have been mechanically pre-cut or countersunk for their largely molding-like mounting at the concerned points of the webs (ribs) 13. Alternatively, at least one of the fundamental areas of the edge profile 18, 19 may consist of a different material than the base body 10.

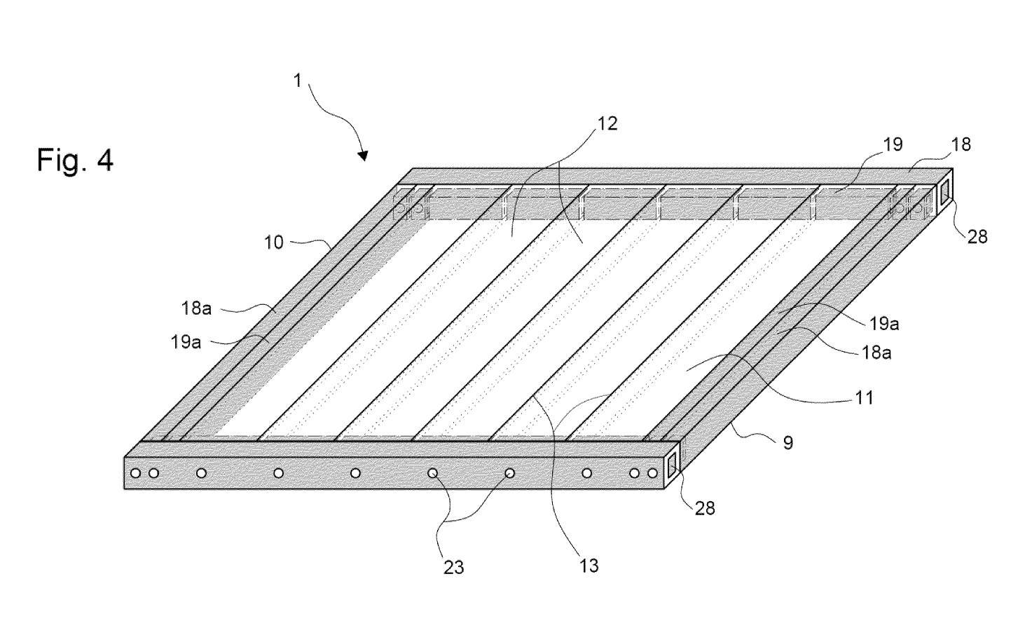

Following the force-fit mounting of the edge profile 18, 19, preferably using the monomer adhesive of the relevant plastic components, it is intended that through the injection points 23 and 28 an elastomer with a low degree of hardness is injected into the edge profile 18, 19, or that it is filled with the elastomer. Equally, the elastomer is injected through the injection point 26 into the primary-seal cavity 30 and through the injection point 27 into the secondary-seal cavity 31. This process creates, as illustrated in FIG. 4, a cover element 1 which features a plastic base body 10 with sealed cavities 12 and on all four sides a double lateral edge profile 18, 19, 18a, 19a which is formed at least partially with an elastomer (in this case silicon).

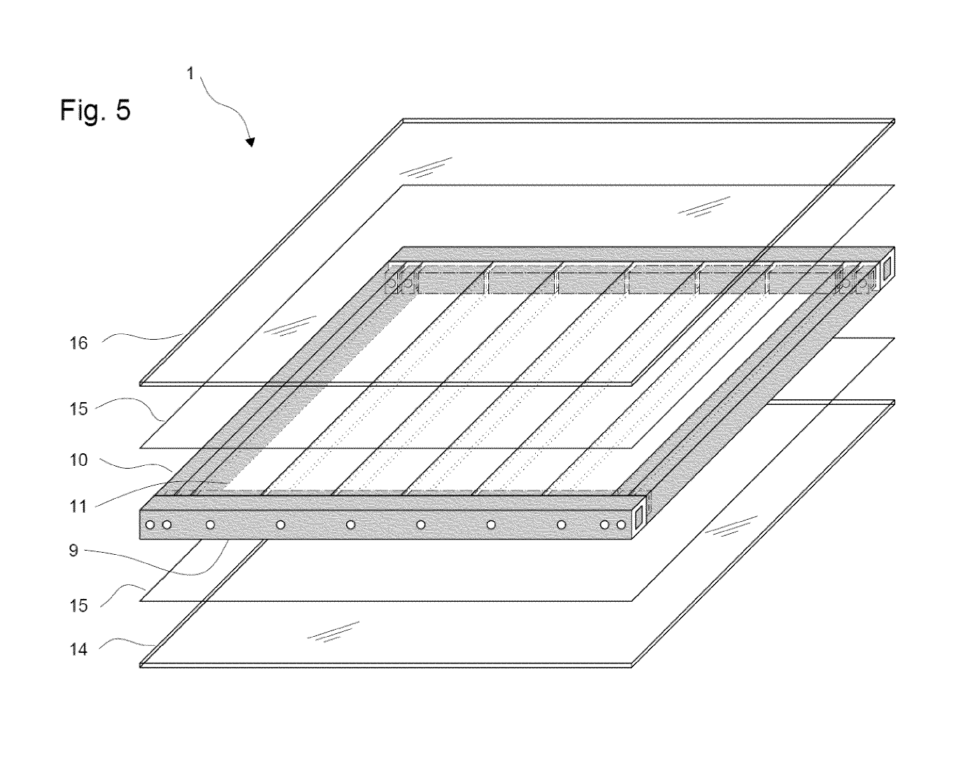

FIG. 5 illustrates the plastic base body 10 as described in FIG. 4 before the force-fit bonding of the bottom exterior side 9 of the plastic base body 10, using an adhesive layer 15 with a thin glass layer 14 featuring a thickness of 1.2 mm, and before the force-fit bonding of the top exterior side 11 of the plastic base body 10, using an adhesive layer 15 with a thin glass layer 16, also featuring a thickness of 1.2 mm.

All embodiment examples described herein have in common that the glass layers 14, 16 are bonded to the exterior sides 9, 11 of the plastic base body 10 which they face, preferably for the large part across the flat surface. Preferably, a combination of materials is selected for the cover element 1 in accordance with the invention where the expansion coefficient of the glass layer 14, 16, adhesive layer 15 and base body 10 ideally correspond or are at least adapted to one another to a large degree. As a result, in accordance with the invention, the adhesive layer 15, due to its elastic properties, has in a sense a regulating function between the expansion of the organic base body 10 (plastic) and the expansion of the non-organic glass layer 14, 16. In other words, according to the invention, an adhesion is provided which allows the plastic base body 10 within its expansion coefficient despite its force-fit bonding with a glass layer 14, 16 to some extent a dynamic without significant negative effect on the cover element and the components now or in the future. In this context, in addition to a bonding which is largely across the flat surface, a partial, i.e. quasi-monolithic bonding can be planned.

In this, the invention is based on the surprising insight that the shear and compressive forces affecting the cover element 1 which occur during the force-fitting process in accordance with the invention do not have an exclusively concentrated impact on the affected glass layer 14, 16 of the cover element, but that they are distributed in part to the components adjoining the glass layer 14, 16 and/or through the webs (ribs) 13 to some extent to other partial areas of the cover element 1. In embodiments featuring an adhesive layer thickness of more than 0.8 mm and in particular when applying an adhesive with a low degree of hardness, the adhesive layer 15 even has in a sense a partially force-absorbing effect against the forces which occur. When very strong forces impact the cover element 1 in accordance with the invention and in instances where e.g. the glass layer 14 facing the interior of the greenhouse breaks, the bonding in accordance with the invention efficiently reduces the dropping of glass shards onto individuals below the cover element.

In this, it can be advantageously intended that the adhesive layer 15 used featuring the above-mentioned generic properties may consist of a castable two-component silicone caoutchouc with a transparency of up to 93%. Preferred embodiments feature an adhesive layer with a thickness of between 0.4 mm and 2 mm. A negative-pressure adhesive technology may be planned for the bonding of the components. In addition, it may be intended that the adhesive layer 15 used with the above-mentioned generic properties may consist of a laminating film with a translucency of up to 93% (also known as EVA film). In preferred embodiments, the thickness of the laminating film is between 0.4 mm and 2 mm. To bond the components, negative pressure and/or roll laminating technology may be intended.

In the embodiments described herein, at last one of the glass layers 14, 16 may comprise e.g. sheet glass, such as sodium silicate glass, float glass or low-iron clear glass with a thickness of preferably between 1.2 mm and 3.2 mm. In addition, it can be intended that at least one of the glass layers 14, 16 comprises borosilicate glass featuring a thickness of between 0.1 mm and 0.6 mm. Finally it can be intended that in a preferred embodiment of the cover element in accordance with the invention at least one of the glass layers 14, 16 features a thickness of between 1.2 mm and 2 mm.

The combination of a plastic base body with a glass layer has generally already been suggested in DE 33 00 408 A1. However, here the combination of plastic base body and glass layer takes the form of a slide bearing or a lubricant to allow a relative movement of the plastic base body and glass layer during thermal expansion and the like. In accordance with the invention it has been proven that in components which are not force-fitted, the weather-facing glass layer is susceptible to breakage, e.g. in hailstorms, if the weather-facing glass layer does not feature a thickness of at least 3.2 mm, preferably 4 to 5 mm, which inevitably leads to significant weight problems. Using a weather-facing glass layer with a material thickness of at least 3.2 mm and to keep the weight of the cover element as low as possible a thin glass plate with a material thickness of 2 mm (or thinner) on the side of the cover element facing the interior of the greenhouse, it has been proven, in contrast, that after initial tension is spent partly already caused by the weight of the superordinate components insignificant additional shear and compressive forces impacting on the cover element may cause the above described thinner glass plate to break very easily, thus posing a serious danger to persons below the cover element.

It is suggested in DE 40 42 265 A1 to apply to one side of a polycarbonate sheet a raw glass sheet with a thickness of at least 5 mm to 10 mm featuring a translucent interlayer, consisting of spun glass fibers soaked in sodium silicate and/or fiberglass matting. Due to the properties of the materials used for bonding, the cover element described is highly translucent and very heavy, since the glass layers used feature a thickness of between 5 and 10 mm. In addition, the cover element does not feature the heat insulation properties which can be achieved by creating a “vacuum” (negative pressure which lies below the ambient pressure) in the cavity/the cavities of the translucent cover element in accordance with the invention, so that the properties and advantages of such a cover element, as required in particular for greenhouse purposes, cannot be achieved.

In addition, the cover element 1 in accordance with the invention differs from that described in DE 10 2008 034 842 A1, among other things, through the absence of a glass encasement which is gastight on all sides, similar to an all-glass double pane, which would result in weight problems. In fact it has been proven, as outlined above, that even a very thin glass layer 14, 16 covering the outer surfaces 9, 11 of the plastic base body suffices to prevent (or significantly reduce) the permeation of air from the ambient air into the inner cavities 12 of the plastic base body 10. For this reason, the translucent cover element 1 in accordance with the invention is particularly well suited as a light-weight construction element to fulfil the requirements of greenhouse construction.

For an optimum and lasting bonding of the components, the plastic base body 10 and/or at least one principal area of the glass layers 14, 16 facing the plastic base body 10 is covered or wetted (coated), preferably across the flat surface, with a primer before being bonded as described above. The primer may consist of solutions and/or aqueous dispersions and is preferably spray-applied.

With respect to the expansion coefficient of the plastic base body 10 and the intended subsequently gas-tight edge cover, it may be intended that the glass layers 14, 16 are up to 4 mm shorter than the external dimensions of the plastic base body 10.

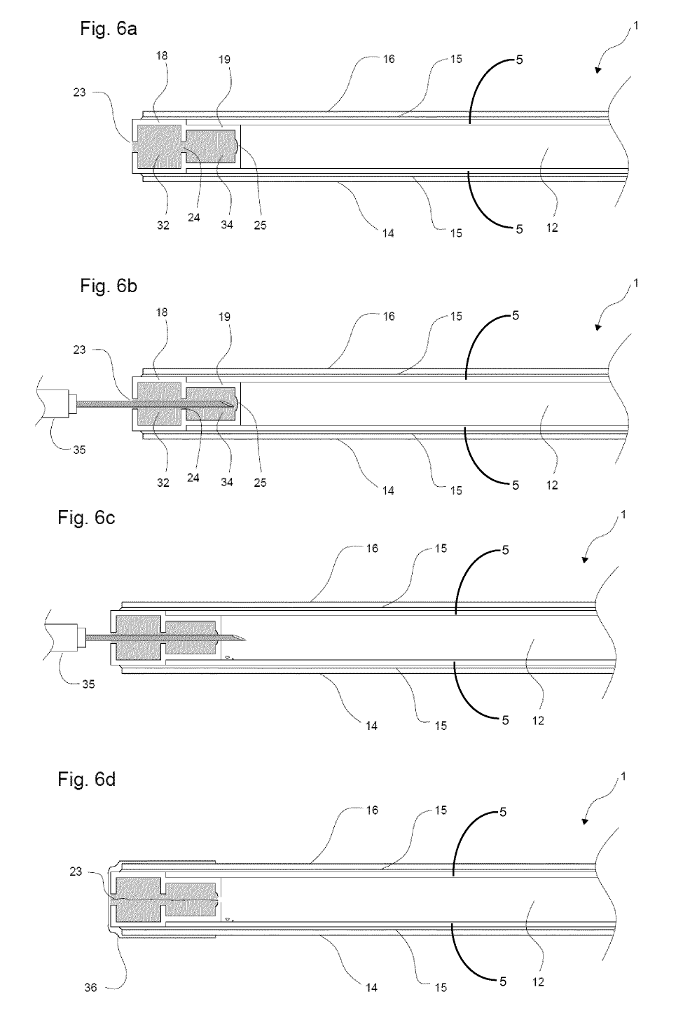

FIGS. 6a-d and 7 illustrate lengthwise cross-sectional views of the cover element 1 of FIGS. 3 to 5 where the glass layers 14, 16 are force-fitted with the panel-shaped principal areas of the plastic base body 10 facing them and the cavities 12 of the plastic base body 10 are sealed with a largely circumferential primary edge profile 18 and a secondary edge profile 19.

In contrast with the exemplary embodiment in accordance with FIGS. 1 and 2, the edge profile 18, 19 is not provided with a conventional evacuation valve 20.

In the embodiment according to FIGS. 6a-d and 7, it is intended that the largely circumferential edge profile 18, 19 of the cover element 1 is filled or injected with an elastomer 32, 34, forming at least one cavity, preferably with natural rubber and/or silicone (shaded in grey in FIGS. 6a-d and 7). It has proven sufficient if at least one of the cavities of edge profile 18, 19, in other words the elastomer component 32, 34 of the edge profile, is between 1 cm and 2 cm.

In accordance with FIG. 6a-6c, it is intended according to the invention to insert through the ports 23, 24 and the evacuation point 25 and consequently also inevitably through the elastomer layers 32, 34 in the edge profile 18, 19 a cannula 35, preferably made of metal, or other hollow needle with a gas-tight connection to a vacuum pump until the hollow needle 35 corresponds with the cavities 12 of the plastic base body 10 which are to be evacuated. In FIGS. 6a-6c, only one evacuation point 25 and a single cannula 35 are illustrated. The present invention, however, also intends an embodiment in which simultaneously through a number of evacuation points 25 an evacuation device, comprising a number of cannulas 35 or hollow needles arranged in a comb-like manner, is inserted.

Here, in the embodiment in accordance with FIGS. 6a-d and 7, the walls of the edge profile 18, 19, which feature a proportion of plastic, have been pierced at the evacuation ports 23 and 24. At evacuation point 25, the corresponding wall has not been pierced but preferably spot-bored so that it can be penetrated by the cannula 35. The spot-bored wall thickness at the evacuation point 25 is selected so that it features on the one hand sufficient stability against the pressure required for the injection or filling of the edge profile 18, 19 with the elastomer compound 32, 34, and on the other hand so that it enables the simplified piercing of the wall at the spot 25 with the cannula 35. It has been shown that in the preferred embodiment of a polymethyl methacrylate (PMMA) cover element 1 a wall thickness of between 0.2 and 0 4 mm is appropriate at the evacuation point 25. Among other things, it can be intended in an alternative embodiment, in which the elastomer compound 32, 34 is injected or filled into the cavities of the edge profile 18, 19 before mounting the edge profile to the plastic base body 10 that the evacuation point 25 is also already pierced or bored, i.e. as an additional evacuation port.

Alternatively, it can be intended that during the manufacturing process of the plastic base body 10 in an extrusion process, at least one edge profile 18, 19 is closed directly during the manufacturing process, still at the thermoforming temperature of the plastic, e.g. with a pressing device. In addition, it can be intended to monolithically form/seal at least one edge profile 18, 19, adding a casting compound. In all possible options for creating the edge profile 18, 19, preferred embodiments of the invention presuppose that during and/or after the forming of the edge profile 18, 19, the edge profile features a primary 18 and preferably a secondary 19 elastomer layer which is suitable for vacuum evacuation in accordance with the invention.

Subsequent to the vacuum evacuation in accordance with the invention through the allocated evacuation ports 23, 24 and the (pierce-able) evacuation point 25 and through the elastomer layers 32, 34, it can be intended that the piercing points of the cannula 35 are sealed gas-tight (as illustrated in FIG. 6d; here, the injection canal of the cannula 35 which runs laterally through the elastomer compound 32, 34 has, as it were, closed again). The invention is based on the surprising insight that after the vacuum evacuation of the cavity/cavities 12 and removal of the cannula 35 the elastic component 32, 34 of the edge profile 18, 19 does not immediately allow the negative pressure generated in the interior of the plastic base body 10 to escape. In fact it has been shown that the perforation point reseals itself efficiently during the removal of the cannula 35 from the elastomer compound 32, 34 contained in the edge profile 18, 19, particularly when using a low-hardness elastomer.

In addition it can be intended that i.e. the perforation point 23 on the side facing away from the vacuum-creating cavity 12 is resealed essentially in a gas-tight manner directly after removal of the cannula 35. The sealing can be achieved i.e. through a drop-like injection of the same elastomer as used in the edge profile 18, 19, another component which bonds monolithically with the elastomer and/or through thermal cauterization of i.e. the perforation point 23.

In addition or alternatively, it can be intended that all areas of the edge profile 18, 18a, 19, 19a which face the ambient atmosphere are force-fit with a largely gas-tight, thin-layer covering means 36 (see FIG. 6d), preferably in a way that the edge cover overlaps at least one of the glass layers 14, 16 by several millimeters to a few centimeters.

For this, it is not absolutely essential that the thin-layer covering means 36 is transparent. For example an aluminum tape may be intended for such a gas-tight edge cover. The edge cover should be attached in a way that also the edge cover allows the plastic base body 10 a certain dynamic within its expansion coefficient.

In one embodiment of the edge cover 36 with an aluminum tape, even a small gaiter in the geometry of the aluminum tape may provide the required scope for the linear expansion of the plastic base body 10.

If the thermal transmittance coefficient (U-value) of e.g. a PMMA triple-wall sheet is typically 2.8 W/m2K approx., an embodiment of the cover element 1 in accordance with the invention featuring a PMMA triple-wall sheet as its base body 10, partially evacuated cavities 12 and a weight of 8 kg/m2 approx. can achieve U-values of up to 0.6 W/m2K permanently or in the very long term. Such a thermal transmittance coefficient is usually only achieved with top-quality triple-pane glazing filled with argon or krypton, using glazing with a weight of 30 kg/m2 approx.

The present invention therefore provides a technical solution which distinguishes itself through a fast, effective and cost-efficient vacuum evacuation. In known vacuum-evacuated, translucent thermoplastic cover elements it has, in contrast, been proven that the application of conventional vacuum valves is subject to significant technical problems. In fact mainly in view of the batch quantities of cover elements required in greenhouse construction the problem of the gastight and force-fitted mounting of a conventional vacuum valve in preferably online process velocity remains entirely unsolved. The height of the edge profile of greenhouse cover elements made of thermoplastic plastics is for structural engineering reasons and stipulations among other things internationally known to be an industry standard of between 8 and 16 mm. In the past it has been shown repeatedly that the low height of the edge profile the point where the vacuum valve should preferably be mounted for technical reasons presents the known vacuum-evacuated cover elements with further significant drawbacks. Particularly in view of the number of vacuum valves required, there is a lack of suitable vacuum valves which fulfil technical (i.e. a low component height) as well as economic feasibility criteria. As a result, intended vacuum-evacuated translucent cover elements have frequently failed to break into the market.

For the vacuum evacuation of the cavities 12 it has been shown that metal cannulas with an external diameter of up to 4 mm and 2 mm cannula diameter are most suitable. Metal cannulas of the type described above are known from the sector of sealing and injection technology.

The preferred embodiment of the edge profile 18, 19 according to the invention, which features a primary elastic edge compound component 18 and a secondary elastic edge compound component 19, has proven to render superfluous the cost-intensive acquisition and complex application of a conventional vacuum valve.

In accordance with the invention, the largely circumferential edge profile 18, 18a, 19, 19a of the translucent cover element 1 is provided in such a way that also on the areas of the edge profile 18, 18a, 19, 19a no air penetrates into the cavity/cavities 12 of the plastic base body or that this effect is significantly reduced in the long term. The invention is in this respect based on the approach that, next to the covering of the main areas of the plastic base body 10 with glass layers 14, 16, only the gas-tight cladding (e.g. injection with an elastomer) of the edge profile 18, 18a, 19, 19a, in other words the greatest possible gas-tight encapsulation of all areas of the plastic base body 10 facing the ambient atmosphere, renders possible significantly and in the long term the technical feasibility of the desired thermal insulation through creating a vacuum.

It is, incidentally, not essential as exemplified in FIG. 2 that the edge profile 18 overlaps the glass layers 14, 16 in a gas-tight manner; in fact the construction could also be chosen in such a way that the glass layers 14, 16 leave free a border area close to the circumferential edge of the cover areas of the plastic base body 10, whereby the edge profile 18 directly connects the two exterior areas 9 and 11 of the plastic base body 10 with each other, allowing the glass layers 14, 16 to be formed particularly thinly.

The present invention is furthermore based on the surprising insight that due to the glass covering 14, 16 of the translucent cover 1 in accordance with the invention, a swelling and reverse swelling of the plastic base body 10 and, as a result, the undesired expansion coefficient of the plastic base body 10, may be reduced by up to 10%. In addition, the permeation of humidity from the ambient air into the interior of the plastic base body 10 is reduced so that, as a result, a fogging of the interior areas of the cover element 1 is significantly prevented. To this effect, it can additionally be intended that in and/or at the edge profile 18, 19 and/or in at least one of the cavities 12 of the cladding element 1 a drying means is provided. Due to the high material density of the glass layer(s) 14, 16, an additional effect is a very efficient, even and sustainable extraction of condensation water which is inevitable, due to high air humidity in a greenhouse, generated on the surface of the cover element facing the interior of the greenhouse. In addition, the translucent cover element 1 is improved in terms of its mechanical and/or chemical properties, in particular its bending strength, scratching resistance and acid-fastness.

In addition, the glass covering 14, 16 of the plastic base body 10 in accordance with the invention significantly reduces the flammability of the translucent cover element 1. As a result, the cover element 1 may be assigned to a high fire protection classification. On the other hand, in terms of their weight and transparency, the preferably thin glass layers 14, 16 have a negative effect on the generic properties of the cover element 1 which is at the most insignificant. In summary it can be noted that in the cover element 1 in accordance with the invention on the one hand the advantages of glass and at the same time those of a plastic cavity are utilized and on the other hand their properties are significantly improved.

It can be intended that in order to optimize the bonding of the relevant glass layer(s) 14, 16 and the area(s) of the plastic base body 10 facing it/them, at least one of the areas of the glass layers 14, 16 to be bonded and/or at least one of the areas of the plastic base body 10 facing the glass layer 14, 16 is structured, i.e. roughened, prismatic and/or rippled. Unilaterally structured thin-layer sheet glass is known, for example, from the sector of photovoltaic systems under the name of patterned solar glass. The surface structure of the plastic base body 10 in accordance with the invention may be performed during the manufacturing process and/or retrospectively, e.g. mechanically.

In addition, it can also be intended that at least one area of the glass layer 14, 16, preferably facing away from the plastic base body 10, features an anti-reflection layer, a low-e coating and/or e.g. a hydrophilic (glass with self-cleaning properties) coating. At least one cavity 12 of the plastic base body 10 may, e.g., be provided with an anti-reflection coating. Finally, it can be intended that at least one substantial area of the glass layer 14, 16, i.e. the internal and/or external side of one or both glass layers 14, 16, consists of diffused glass.

In addition, a partial reduction of the expansion coefficient of the plate-shaped elements 5 and/or the plastic base body 10 may also be intended through the arrangement, the direction and/or the angles of the webs (ribs) 13 and/or the formation of the edge profile 18, 19.

The invention is based on the additional surprising insight that it is sufficient, particularly in a preferred embodiment of the translucent cover element 1 in which the plastic base body 10 consists of polymethyl methacrylate (PMMA), to create the parallel panel-shaped elements 5 of the plastic base body 10 which are arranged at a mutual distance up to 30% thinner than familiar cover elements. This makes it possible to manufacture the translucent cover element 1 in accordance with the invention at lower cost and with an even lower weight. Before and/or during the creation of the edge profile 18, 19 it can additionally be intended to reduce humidity inside the cavities 12 of the plastic base body 10 to counteract the undesirable linear expansion of the plastic base body 10 to below 40% and preferably to below 30%. For this reason, it is suggested to perform the creation of the edge profile 18, 19 e.g. in a clean-room facility featuring the above humidity values.

The cavities 12 of the cover element 1 can be at least partly evacuate-able. In this, at least one embodiment intends that no vacuum is created in at least one cavity 12 of the cover element 1. As a result, in regions with heavy snowfalls on the weather-facing surface of the cover element 1, where no vacuum is created, a higher thermal convection takes place, disrupting the blanket of snow in linear direction, which supports the melting and/or sliding-off of the snow cover in the direction of a gutter/rainwater drainpipe to support an optimum clearance of the greenhouse roof area. In an alternative embodiment, at least one cavity 12 of the cover element 1 may be filled with an essentially translucent insulating means, such as argon and/or krypton gas.

In contrast to a greenhouse covered with known cover elements, where a boiler and/or CHP generator with a heating power of up to several megawatts are required, a greenhouse covered with cover elements in accordance with the invention requires a significantly smaller boiler and/or a smaller CHP generator to heat water. As a result, the savings made due to the smaller size of the boiler system and considerable additional savings in all components and/or installations connected to the boiler upstream and downstream finance approximately ⅔ of the initial investment required for a greenhouse covered with translucent cover elements in accordance with the invention.

Economic calculations prove that the remaining approximately ⅓ of the initial investment achieve their break-even point after a few years of additional savings in heating costs.

In addition, a greenhouse covered with cover elements in accordance with the invention produces significantly lower CO2 emissions over decades.

The properties of the invention as presented in the above description, in the figures and in the claims can, individually or in arbitrary combination, be fundamental for the realization of the invention in its different embodiments.

### LIST OF REFERENCE NUMERALS

1 Cover element

5 Panel-shaped element

9 Bottom exterior side of the plastic base body

10 Plastic base body

11 Top exterior side of the plastic base body

12 Cavity

13 Web (rib)

14 Glass layer

15 Adhesive layer

16 Glass layer

18 Primary edge profile longitudinal side

18a Primary edge profile transverse side

19 Secondary edge profile longitudinal side

19a Secondary edge profile transverse side

20 Evacuation valve

23 Injection point elastomer, plus evacuation port/primary seal

24 Injection point elastomer, plus evacuation port/secondary seal

25 Spot-bored, penetrable evacuation point of the wall facing the cavity

26 Injection point for edge profile 18a

27 Injection point for edge profile 19a

28 Injection point for edge profile 18

30 Cavity of edge profile 18a

31 Cavity of edge profile 19a

32 Elastomer in edge profile 18

34 Elastomer in edge profile 19

35 Cannula

36 Covering means

What is claimed is:

1. Transparent heat-insulating cover element (1), in particular for greenhouse covers, comprising:
a base body (10) comprising at least two parallel panel-shaped elements (5) being spaced apart from each other; and
at least one lateral edge profile (18, 18a, 19 19a) forming, in combination with the base body (10), at least one cavity (12) which is essentially sealed against the external atmosphere; wherein
the base body (10) is, on at least one of its outer surfaces (9, 11) which is averted from the at least one cavity (12), force-fit bonded to a glass layer (14, 16) by means of an adhesive layer (15); characterized in that:
at least one of the glass layers (14, 16) comprises a thickness of between 0.1 and 3.2 mm; and
a material combination is selected in which the expansion coefficients of the glass layer (14, 16), the adhesive layer (15) and the base body (10) essentially correspond; such that
the adhesive layer (15) has a regulating effect between the expansion of the glass layer (14, 16) and the base body (10).

2. Cover element (1) in accordance with claim 1, wherein at least one of the glass layers (14, 16) comprises a thickness of between 1.2 and 2 mm.

3. Cover element (1) in accordance with claim 1, wherein a surface of the at least one glass layer (14, 16) which faces the base body (10) and/or at least one of the external surfaces (9, 11) of the base body (10) is structured.

4. Cover element (1) in accordance with claim 1, wherein at least one surface of the at least one glass layer (14, 16) and/or at least one surface of the base body (10) comprises at least one inherently beneficial coating, in particular an antireflection coating, a low-e coating, a hydrophilic coating and/or a primer with a thickness of preferably between 1 and 60 micrometers.

5. Cover element (1) in accordance with claim 1, wherein at least one of the panel-shaped elements (5) of the base body (10) consists essentially of a transparent thermoplastic plastic, in particular of polymethyl methacrylate (PMMA) and/or of polycarbonate (PC).

6. Cover element (1) in accordance with claim 1 wherein the edge profile (18, 18a, 19, 19a) comprises an at least partly elastic primary edge profile (18, 18a) and an at least partly elastic secondary profile (19, 19a).

7. Cover element (1) in accordance with claim 1, wherein the interior of the base body (10) has a humidity of below 40% after formation of the circumferential edge profile (18, 19, 18a, 19a).

8. Cover element (1) in accordance with claim 1, wherein the at least one cavity (12) of the base body (10) is at least partially vacuum evacuate-able and/or wherein in at least one of a plurality of cavities (12) of the base body (10) a vacuum is created and in at least one of the cavities (12) no vacuum is created.

9. Cover element (1) in accordance with claim 1, wherein the edge profile (18, 19) is at least partially filled with an elastomer (32, 34) and comprises evacuation ports (32, 24) and at least one evacuation point (25), wherein the evacuation ports (23, 24), the elastomer (32, 34) and the at least one evacuation point (25) is pierce-able by a cannula (35) for an at least partial vacuum evacuation of at least one cavity (12) of the cover element (1) and wherein the elastomer (32, 34) seals the created penetration point during the removal of the cannula (35) so that it is essentially gas-tight.

10. Cover element (1) in accordance with claim 1, wherein the edge profile (18, 19) is covered with a, preferably thin-layered and gas-tight, covering means (36), preferably so that the covering means (36) overlaps at least one of the glass layers (14, 16).

11. (canceled)

12. Edge profile (18, 19) for a transparent heat-insulating cover element (1), wherein:
the edge profile (18, 19) is filled at least partially with an elastomer (32, 34);
wherein the edge profile (18, 19) comprises evacuation ports (23, 24) and at least one evacuation point (25); wherein the evacuation ports (23, 24), the elastomer (32, 34) and the evacuation point (25) is pierce-able by a cannula (35); and
wherein the elastomer (32, 34) seals the created penetration point during the removal of the cannula (35) so that it is essentially gas-tight.

13. Method for the vacuum evacuation of a transparent heat-insulating cover element (1), comprising the following steps:
piercing of an elastomer (32, 34) provided in an edge profile (18, 19) of the cover element (1) with a cannula (35);
at least partial vacuum evacuation of at least one cavity (12) of the cover element (1); and
essentially gas-tight sealing of the created penetration point by the elastomer (32, 34) during the removal of the cannula (35).

14. Method in accordance with claim 13, wherein a plurality of chambers of the edge profile (18, 19) which are at least partially filled with an elastomer (32, 34) are simultaneously pierced by an evacuation device comprising a plurality of cannulas (35) arranged in a comb-like manner.

15. (canceled)
